(19) United States
(12) Patent Application Publication
(10) Pub. No.: US 2008/0275714 A1
(43) Pub. Date: Nov. 6, 2008

(54) COMPUTERIZED REQUIREMENT MANAGEMENT SYSTEM

(76) Inventor: David Frederick Martinez, Cypress, TX (US)

Correspondence Address: TRAN & ASSOCIATES, 6768 MEADOW VISTA CT., SAN JOSE, CA, 95135, US

(21) Appl. No.: 11/742,708

(22) Filed: May 1, 2007

(51) Int. Cl. G06Q 10/00; G06Q 50/00

(52) U.S. Cl. 705/1

(57) ABSTRACT

Systems and methods are disclosed to analyze construction materials, contract and management plans, components or blends by accessing a server located on a wide-area-network; sending information collected from the materials, components or blends to the server; applying one or more test or inspection methodologies to the collected information; performing one or more audits; generating one or more quality management reports from the test methodologies and the audits; and sending the one or more quality management reports to a project manager.

### COPYRIGHT RIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF INVENTION

The present invention relates to a computerized requirement management system.

As modern commerce depends on reliable and cost-effective methods for delivering products from suppliers to users, the availability of durable and reliable highways, roads and other support surfaces for vehicles is vital for sustaining a modern economy. To provide better support surfaces, highways, roads, and sidewalks are frequently paved with a layer or mat of asphalt concrete that is laid over the surface of the sub-base.

The concrete needs to be tested. The testing of construction materials is performed as a quality control and quality acceptance function (a quality assurance program) to test materials and workmanship quality. Typically, laboratory testing is performed for materials and in-place inspection is performed for workmanship. Laboratory testing of material quality directly measure the conformance with material specifications.

To ensure that the materials conform to the specification, various tests have been developed for standard test methods for Quality Assurance/Quality Control of soils, aggregates, asphalt, cement asphalt and concrete mixes. The testing technology is rapidly changing due to increasing demands in the material laboratory to provide new levels of service. These new levels of service must be more cost effective to decrease the operating expenditures such as labor cost and the like, and must provide shorter turnaround time of test results as well as improve the accuracy of the analysis. Modernization of analytical apparatus and procedure demands consolidation of workstations to meet the growing challenge placed on the material testing laboratories.

Many construction projects are performed today with contracts that include performance-based specification as part of payment incentives. Tracking quality control and acceptance results on a real-time basis allows contractors to keep material processes within specifications to maximize bonus payments as part the contract payment incentives. Also, real-time quality control tracking allows the contractors for avoid penalties for putting non-conforming material in-place. This reduces the amount of removal of non-conformance materials or minimized the payment penalties for materials outside of specifications.

### SUMMARY

In one aspect, systems and methods are disclosed to analyze construction materials, contract and management plans, components or blends by accessing a server located on a wide-area-network; sending information collected from the materials, components or blends to the server; applying one or more test or inspection methodologies to the collected information; performing one or more audits; generating one or more quality management reports from the test methodologies and the audits; and sending the one or more quality management reports to a project manager.

Implementations of the aspect may include one or more of the following. The method can provide an Internet browser interface to access the server located on the wide-area-network. The computer-implemented method can apply aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

Advantages of the system may include one or more of the following. The system allows a user to analyze material testing data from beginning to end using one centralized resource. This makes the material testing process easier to understand for the user and allows the user to control and monitor progress relating to the analysis of the materials.

The system completes a material analysis transaction with many users, keeping track of what each user is doing and progress. The system allows the entire process to be accessible from one central location on a network. The system is also efficient and low in operating cost. It also is highly responsive to user requests.

Other advantages and features will become apparent from the following description, including the drawings and claims.

### BRIEF DESCRIPTION OF THE DRAWINGS

FIG. 1 shows an exemplary Requirements Management System (RMS).

FIG. 2A shows an exemplary Real Time Score Card.

FIG. 2B shows an exemplary audit triad.

FIG. 2C shows an exemplary report that shows On-going Issues, Current Issues and Issues under control based on quality and risk levels.

FIG. 3A-3B show various exemplary audit cycles.

FIG. 4 shows an environment for processing material test quality control or quality assurance transactions.

FIG. 5 shows one embodiment of a process for processing material test information.

FIGS. 6A-6E show an exemplary process and various exemplary user interfaces for performing gyratory compaction.

FIGS. 7A-7F show an exemplary process and various exemplary user interfaces for performing ignition tests on materials.

FIG. 8 shows another exemplary RMS.

### DESCRIPTION

Referring now to the drawings in greater detail, there is illustrated therein structure diagrams for a requirement management system and logic flow diagrams for the processes a computer system will utilize to complete the requirement management process. It will be understood that the program is run on a computer that is capable of communication with users over a network, as will be more readily understood from a study of the diagrams.

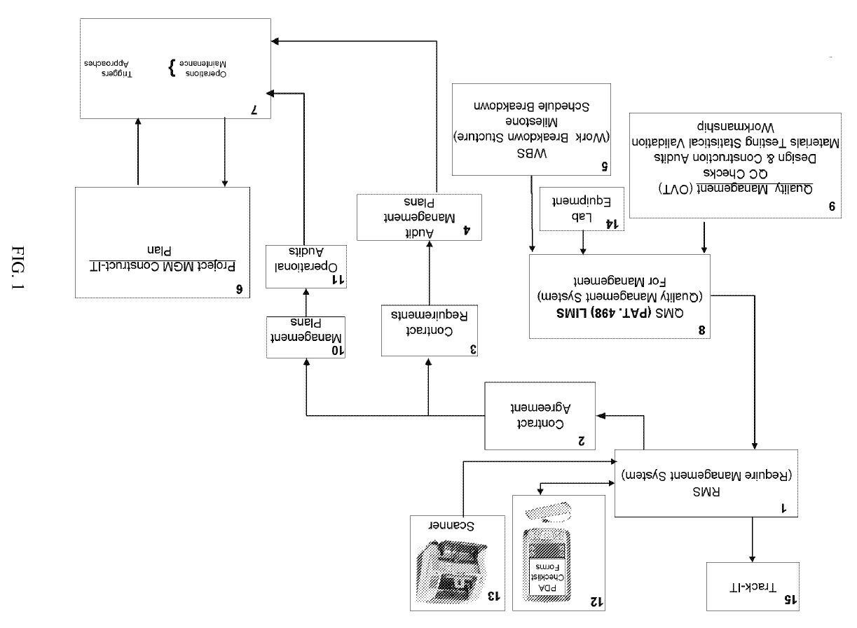

Referring now to FIG. 1, an exemplary Requirements Management System (RMS) 1 is shown. RMS 1 interfaces with a contract system 2 that manages Contract Agreements between owners and concessionaires. The contract system 2 in turn communicates with a contract requirements system 3 that performs management audit of contract requirements between owner and concessionaire. The contract requirements system 3 in turn communicates with an audit management system 4 where a concessionaire prepares project Facility Management Plans (FMPs). The FMPs are reviewed and approved by the owner. The Owner oversight team audits concessionaire for compliance with approved plans.

A Work Breakdown Structure (WBS) 5 provides an interface to scheduling software to link scheduled milestones and activities to audits. The WBS 5 communicates with a Quality Management System (QMS) 8.

A project management plan system 6 provides tools where concessionaire planning, design and construction activities can be reviewed and audited. The system 6 communicates with an Operation and Maintenance system 7 that specifies procedures where triggers and approaches can be audited for compliance with the owner contract.

The QMS 8 or Laboratory Information Management System (LIMS) interfaces with lab equipment 14 and other peripheral devices such as OCR scanners and PDAs across the Internet. More information on the QMS 8 is disclosed in U.S. Pat. No. 6,826,498, the content of which is incorporated by reference. Customers use a web based version of the QMS 8 to perform QC (quality control), QA (quality assurance), OVT (owner verification testing) and IA (Independent Audit), among others.

The QMS 8 receives data from a Quality Management system 9 that includes results of the statistical validation of sampling and testing along with workmanship/ inspection checklists.

The contract system 2 also communicates with a Management Plan system 10 that supports auditing of the contract requirements. The system 10 in turn drives an Operational Audit system 11 that includes auditing of the Management Requirements generated by a developer.

The RMS 1 also communicates with one or more personal digital assistants (PDAs) 12. The PDA can support a fully customizable checklist system for construction compliance. The PDA can also facilitate customized testing forms for all types of material and structural compliance. Additionally, an audit requirement checklist can be supported that is integrated with the RMS 1. The RMS 1 can communicate with one or more scanners 13. The scanners have many uses in web based applications: data that need to be provided to the QMS 8 that is externally created can be scanned and imported into the system. The scanners can also be used to highlight audit plans into the system from requirements documents into the system. The QMS 8 also communicates with Lab Equipment 14 through custom interfaces built between Laboratory scales, ignition ovens, concrete break machines, and equipment to measure confined and un-confined compressive strength, among others.

The RMS 1 can also communicate with a web based document control system for storing all items used on a project. The system includes the ability to process items through a routing and approval system, this feature is used for routing drawings, contract revisions, among others.

In one implementation, the RMS system is implemented using Microsoft's .NET system and connects to either a Microsoft SQL Server or an Oracle database. The web-based system can be used online through the Internet or can be internally hosted via the customer's private intranet. One embodiment enforces role based security: based on the user's login and password, the user will have certain rights in the system depending on the role the user is assigned. The roles are customizable per project.

The system can be used at the program, project, or contract level system. The system is an enterprise level system that integrates all the components related to an audit (i.e. Handheld Computer, Document Control, Geographical Information System (GIS), LIMS, and Scheduling System, among others) into a single structured relational database where information can be easily accessed. The WBS or outline structure allows for an easy to use hierarchical view of requirements per project or per client. The work breakdown structure is completely customizable.

The system can interface with any scheduling tools to allow for auditing milestones and triggers to be imported into the system. The audits can then be tracked against an approved schedule. The requirements module allows customers to create, modify, and view requirements as well as search for prior requirements to assist in writing current or future requirement documents. The audit requirements include Management, Design, Construction, Operation and Maintenance. The system is integrated with the LIMS system to allow for Design and Construction audits.

The management requirements are based on contractual requirements between the owner and the facility provider or concessionaire. The Operation requirements can include all the management requirements generated by a Developer. The Maintenance requirements can include all maintenance activities and triggers that are developed under the Quality Assurance procedures. The requirement module can be searched by document, WBS, activity name, activity number, requirement number, description, level, or keyword. The Audit module allows the user to create audit checklists based on the requirements that the user has selected to be audited. The types of audits checklists that can be generated include Management, Design, Construction, Operations and Maintenance checklists. The audit checklists are integrated with Handheld Computer for the auditor to take to the site and fill out and the data can be synchronized or saved on the database. The data can be synchronized wirelessly, or if a wireless connection is not available, through a wide area network WAN. Audit Reports can be generated based on the audit checklist data. The Audit Report section allows the customer to easily attach files to the system such as audit reports, evidence, issues, and schedules.

The system communicates with the LIMS that allows for tracking of Inspection and Workmanship checklists and conformance of the checklist auditing. The system also captures the results of the statistical validation of sampling and testing. A Non-Conformance module allows the user to track all the non-conformances that was generated during the audit process. The system also provides customizable work flow that will notify user immediately on noncompliance issues and project deficiencies. An issue tracking log allows users to issue statuses and comments for each non-compliance report (NCR). Each of the updates to the issue tracking log are time stamped in the system. Once an NCR is closed the status is updated and the NCR is moved to the closed list. A trend analysis can be performed to determine how the NCR's are progressing. An advanced search capability allows the customer to search through all the NCR reports based on the selected search criteria.

The system also communicates with a document control system that will allow electronic versions of the management plans, audit reports, and non-conformance reports to be automatically generated and saved in the WBS tree structure.

The system is also fully integrated with the GIS system that allows the various audit locations to be tracked on a map. Each audit point will display on the map and when audit point is selected a list of the audit documents and requirements will display along with all the non-conforming issues. If further detail is required the user can drill down and view detail information on each audit.

The system enables contract requirements to be listed and tracked for compliance. Metric reports citing compliance can be easily issued. The system also hosts QA Management Plan, Safety Management Plan, Design Quality Management Plan, Construction Quality Management Plan, Utilities Management Plan, etc. These plans are logged within the system and easily permit their audits.

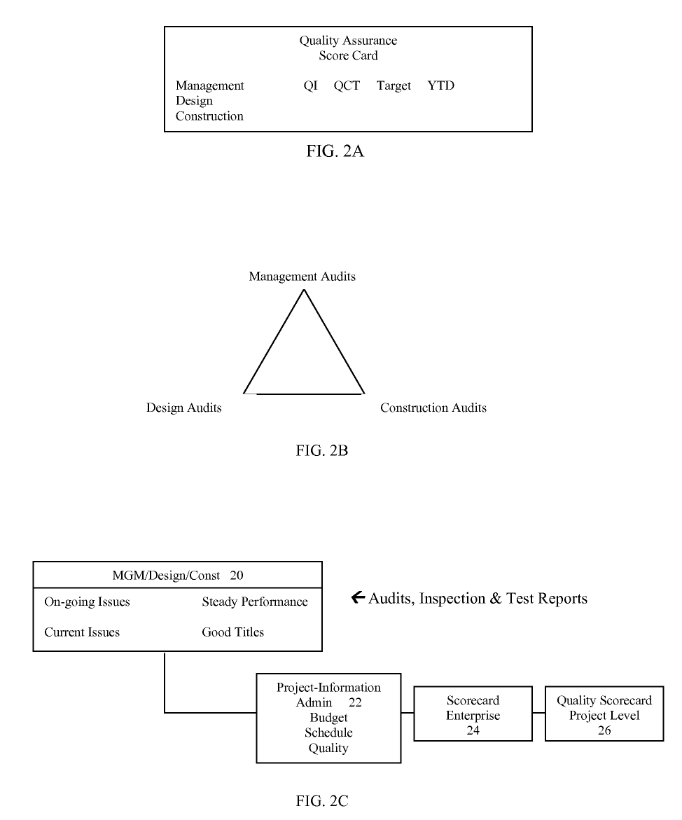

The system makes use of a Real Time Score Card as exemplified in FIG. 2A. The score card shows quality index (QI), quality control trend (QCI), target, and year to date (YTD) information, among others. The score card can provide Lead and Lagging Indicators that trigger user alerts based on defined action levels. Monthly Quality Status Reports can be generated for managing the construction project based on management, design and construction audits and test results.

FIG. 2B shows an exemplary audit triad. Management audits can be done to check on the management of the facility. Design/Construction audits can be done during the design and construction of the facility. Additionally, Operation and Maintenance audits can be done to test whether the facility is properly maintained.

In one embodiment, the system performs the following:

1. Prepare Guidelines for Audits

2. Prepare Maintenance Approaches/Maintenance Triggers

3. Prepare Procedures

4. Contract Requirements between Owner and the Facility Provider/Concessionaire. The RMS assists in performing Management Audits.

5. Facility Provider/Concessionaire is required to develop Management Plans. The RMS includes checklists to audit FP compliance with approved plans.

FIG. 2C shows an exemplary report that shows On-going Issues, Current Issues and Issues under control based on quality and risk levels (20). The report can track and show Project-Information (22) such as administration, budgeting, scheduling, and quality information impacts. The report can also show scorecards 24-26 at the enterprise and project levels.

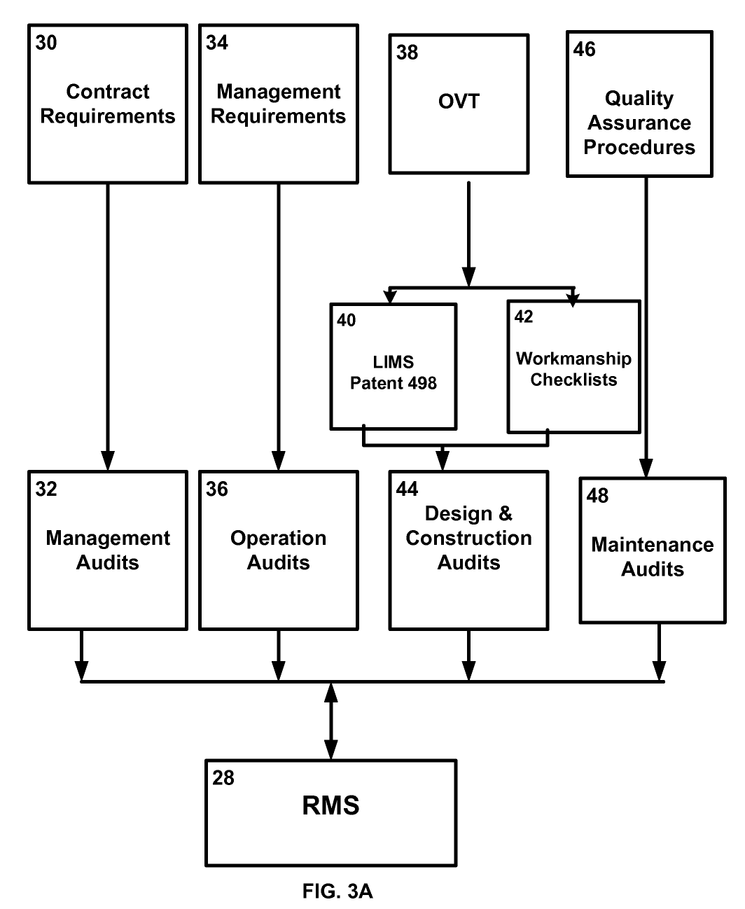

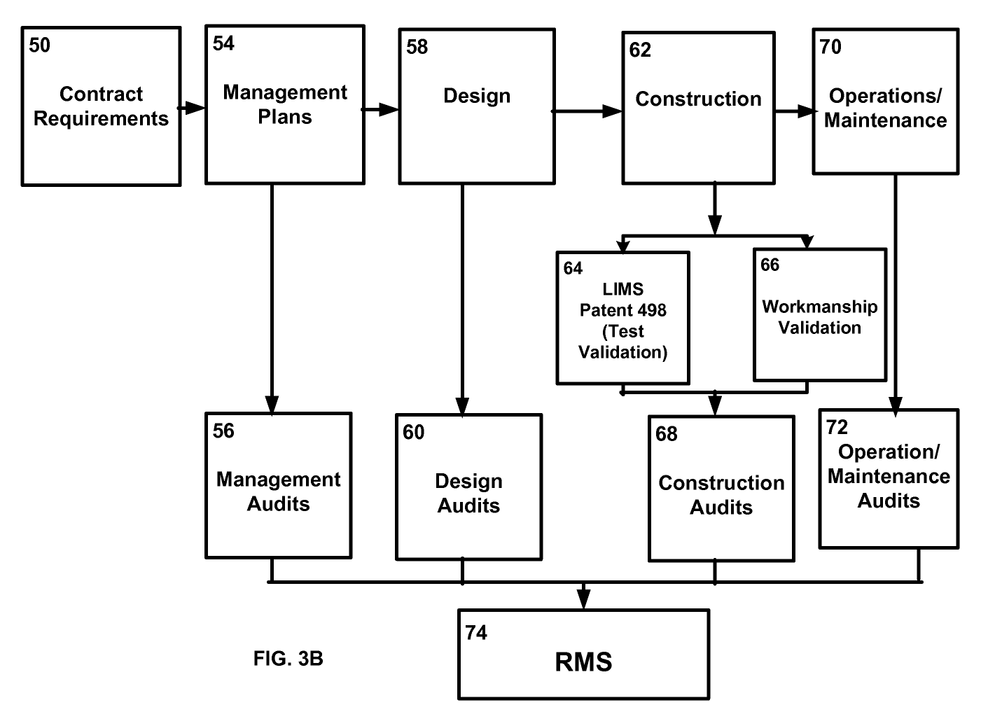

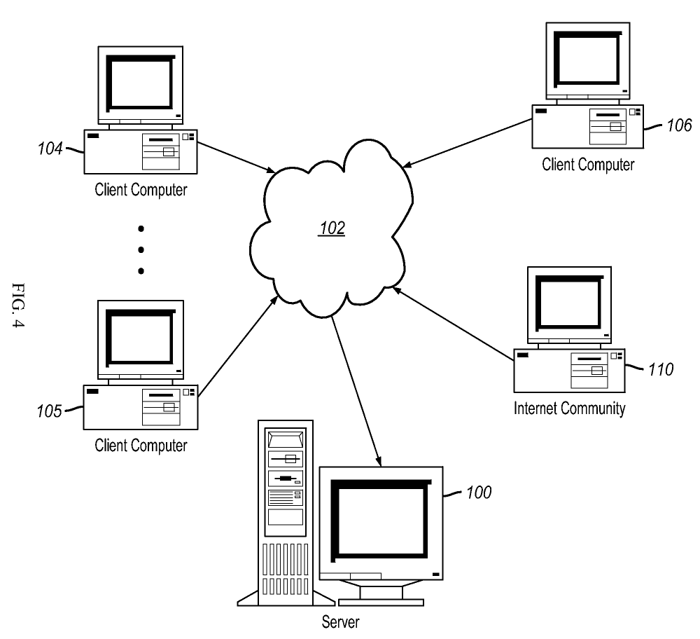

FIG. 3A shows one exemplary audit cycle that includes the following audits:

1. Management Audits which include auditing of the Contract Requirements

2. Design and Construction Audits related to OVT that would include results of the statistical validation of sampling and testing along with workmanship/inspection checklists

3. Operational Audits which include auditing of the Management Requirements generated by Developer in accordance with Owner guide

4. Maintenance Audits would include auditing all maintenance activities and triggers that are developed under the Quality Assurance Procedures

In this cycle, contract requirements are captured (30) and provided for management audits (32). Similarly, management requirements are captured (34) and used for operation audits (36).

Also, owner verification testing requirements can be captured into the LIMS (40) and the workmanship checklist (42), both of which in turn provide information for design and construction audits (44).

Additionally, quality assurance procedures are captured (46) and provided to maintenance audits (48). The outputs of the audit processes 32, 36, 44 and 48 are provided to an RMS 28.

FIG. 3B shows a corresponding audit cycle for operation and maintenance issues. The audits cover the following:

1. Contract Requirements between the Owner and Developer

2. Management Audits which include auditing of the Contract Requirements

3. Design and Construction Audits related to OVT that would include results of the statistical validation of sampling and testing along with workmanship/inspection checklists

4. Operational Audits which include auditing of the Management Requirements generated by Developer

5. Maintenance Audits would include auditing all maintenance activities and triggers that are developed under the Operations/Maintenance Procedure

In FIG. 3B, contract requirements are captured (50) and provided to the management plans (54), which in turn are provided for management audits (56). From the management plans, information is provided for the design requirement capture (58). The design information is then used in the design audits (60). From the design requirements, construction requirements are captured (62). This information is processed by the LIMS 64 and the workmanship validation (66), both of which are used by the construction audits (68). Additionally, from the construction phase, operation and maintenance data is generated (70) and provided to operation and maintenance audits (72). From the audits 56, 60, 68 and 72, RMS 74 can provide statistics and other useful information to interested stakeholders such as owners and operators.

The RMS 1 works with the QMS 8 which in turn receives information from lab equipment 14. FIG. 4 shows an environment for supporting the RMS 1 in handling a laboratory material analysis. A server 100 is connected to a network 102 such as the Internet. One or more client workstations 104-106 are also connected to the network 102. The client workstations 104-106 can be personal computers or workstations running browsers such as Netscape or Internet Explorer. With the browser, a client or user can access the server 100's Web site by clicking in the browser's Address box, and typing the address (for example, www.atser.com), then press Enter. When the page has finished loading, the status bar at the bottom of the window is updated. The browser also provides various buttons that allow the client or user to traverse the Internet or to perform other browsing functions.

An Internet community 110 with one or more building construction companies, service providers, manufacturers, or marketers is connected to the network 102 and can communicate directly with users of the client workstations 104-106 or indirectly through the server 100. The Internet community 110 provides the client workstations 104-106 with access to a network of test service providers.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 allows a consumer to log onto a computerized laboratory analysis software package incorporating AASHTO,ASTM or a state agency version of standard test methods for Quality Assurance/Quality Control of soils, aggregates, asphalt, cement asphalt and concrete mixes. Information relating to the various portions of a transaction are captured and stored in a single convenient location where it can be accessed at any time.

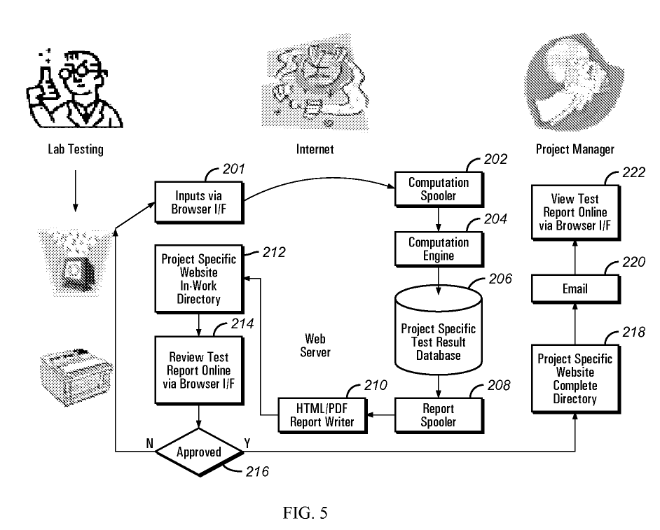

FIG. 5 shows an exemplary process 200 for providing a network-based Laboratory Information Management System (LIMS) on the server 100. First, browser based user interfaces are used to collect test result inputs (step 201). These inputs are collected by the server 100 and provided to a computation spooler (step 202). The spooler activates a computation engine performing the appropriate engineering calculation (step 204) and writes this information to a project specific test result database (step 206). The process 200 then activates a report spooler (step 208). The report spooler then sends output information to a report writer that stores this information in an In-Work directory for each project for review by a lab manager (step 210). In one embodiment, the report writer can generate HTML or PDF documents for viewing.

The lab manager classifies the test results (step 212). Unapproved test results will require updates to the test inputs, recalculation of results, and re-posting of the information to the In-Work website directory. Approved test reports will be promoted to the completed directory on a project specific website. The project specific website directories provide for data security and separation of client's project specific information. The process 200 sends an email notification to a Project Manager for viewing of the final report online (step 214).

The computer-implemented method can apply one or more test methodologies, for example aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

By supporting a plurality of test methodologies, the process of FIG. 3 offers a comprehensive laboratory analysis incorporating AASHTO and ASTM standard test methods for Quality Assurance/Quality Control of soils, aggregates, asphalt, cement asphalt and concrete mixes.

The computer-implemented method can apply aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

In one implementation, the following aggregate calculations are done. The Los Angeles Abrasion method covers the procedure for testing coarse aggregate for resistance to degradation using the Los Angeles testing machine, as defined in AASHTO T96, ASTM C131. The soundness test measures aggregate resistance to disintegration according to AASHTO T104. The 24 Hour Water Absorption test method covers the determination of specific gravity and absorption of coarse aggregate pursuant to AASHTO T85-91, ASTM C127-88. The sand equivalent serves as a rapid field test to show the relative proportion of fine dust or claylike material in soils or graded aggregates. The Unit Weight and Voids in Aggregate test method covers the determination of unit weight in a compacted or loose condition and calculated and in fine, coarse, or mixed aggregates based on the determination under ASTM C29, AASHTO T19. The specific gravity, water absorption and moisture method is used to determine the bulk specific gravity and water absorption of aggregate retained on a No. 80 sieve, as defined in ASTM T84. The clay lumps and friable particles in aggregate method covers the approximate determination in clay lumps and friable particles in natural aggregates, per AASHTO T112-91. The sieve analysis method is used to determine the particle size distribution of aggregate samples, using sieves with square openings under ASTM C136, ASSHTO T27

For soils, the Soil Liquid, Plastic Limit and Plasticity Index procedure determines the liquid limit of soils, defined as the water content of a soil at the arbitrarily determined boundary between the liquid and plastic states, expressed as a percentage of the oven-dried mass of the soil. It also determines the plastic limit and plasticity index in soil as defined in ASSHTO T89,90,91. The Material in Soil Finer then #200 Sieve method determines the amount of soil material finer than the 75 μm (No. 200) sieve under AASHTO T11, ASTM D1140. The Moisture and Density of Soil-Aggregate In-Place by nuclear method covers the determination of the total or wet density of soil and soil aggregate in-place by the attenuation of gamma rays. The Moisture Content method covers the laboratory determination of the moisture content of soil under AASHTO T265. The specific gravity of soils method covers the determination of the specific gravity of soils by means of a pycnometer under AASHTO T100-95, ASTM D854-83 The Unconfined Compressive Strength of Cohesive Soil method covers the determination of the unconfined compressive strength of cohesive soil in the undisturbed, remolded, or compacted condition as discussed in AASHTO T208-96, ASTM D2166-85. The sieve analysis of fine and coarse aggregates method covers the determination of the particle size distribution of fine and coarse aggregate by sieving, as discussed in AASHTO T27-97, ASTM C136-95A. The compaction test is intended for determining the relation ship between the moisture content and density when compacted under ASSHTO T99,T180, ASTM D698,D1557. The California Bearing Ratio (CBR) method covers the determination of the (CBR) of pavement subgrade, subbase, and base/course material from laboratory compacted specimens under AASHTO T193-98. The density and unit weight of soil in place by the sand-cone method may be used to determine the in-place density and unit weight of soils using a sand cone apparatus as discussed in ASTM D1556.

For asphalts, the extraction method covers the recovery by the Abson method of asphalt from a solution from a previously conducted extraction (ASTM D1856, ASHTO T170). The emulsion test is described under the headings titled Composition, Consistency, Stability, and examination of residue of ASTM 244, ASSTO T59.

For asphalt mix, the ignition test method covers the determination of asphalt content of hot-mix asphalt (HMA) paving mixtures and paving samples by removing the asphalt content at 540 C by ignition in a furnace, per ASTM D6307-98. The actual specific gravity (BSG, Gsb) test method covers the determination of bulk specific gravity of specimens of compacted bituminous mixtures, per AASHTO T166. The theoretical maximum (Rice, or Gmm) specific gravity test method covers the determination of the theoretical maximum specific gravity and density of uncompacted bituminous paving mixtures at 25 C pursuant to AASHTO T209. The tensile strength ratio method covers preparation of the specimens and measurement of the change of diametral tensile strength, per AASHTO T283-89. The Marshall stability test method covers the measurement of the resistance to plastic flow of cylindrical specimens of bituminous paving mixture loaded on the lateral surface by means of Marshall apparatus, per ASTM D1559-89. The Hveem Stability test methods cover the determination of (1) the resistance to deformation of compacted bituminous mixtures by measuring the lateral pressure developed when applying a vertical load by means of Hveem stabilometer, and (2) the cohesion of compacted bituminous mixtures by measuring the force required to break or bend the sample as a cantilever beam by means of the Hveem cohesiometer, per ASTM D1560-92. The voids calculation method covers determination of the percent air voids in compacted dense and open bituminous paving mixtures, as described in AASHTO T269.

The concrete mix test includes the Unit Weight, Yield, and Air Content of Concrete Mix test method that covers determining the weight per cubic meter (cubic yard) of freshly mixed concrete and gives formulas for calculating yield, cement content, and air content of the concrete. Except for editorial differences, this procedure is the same as ASTM C 138 and AASHTO T 121. The Quality of Water to be used in Concrete test method tests for acidity or alkalinity, per AASHTO T26-79. The Compressive Strength of Cylinder Concrete Specimens method covers determining compressive strength of cylindrical concrete specimens such as molded cylinders and drilled cores. . The flexural strength of concrete test method covers the determination of flexural strength of concrete by the use of a simple beam with third-point loading, per AASHTO T97-86, and ASTM C78-84. The air content method determines the air content of freshly-mixed concrete by observation of the change in volume of concrete with a change in pressure, as described in AASHTO T152-97 and ASTM C231-91B.

The process of FIG. 5 also includes full automatic report generation capability with forms stored within the system. Graphing capabilities include Proctor, PI test, Control Chart, statistical and standard deviation analysis and others. The software can statistically compare test results. Statistical comparisons are performed by over-plotting the contractors' quality control test results and the owners' quality acceptance results. Statistical test are then performed to evaluate the mean, standard deviation, sample size, test frequencies, cumulative frequencies, percent within-limit, percent out-of-limit, F-test (variability testing), T-test (means testing). These statistical tests are important for contractors and owners to determine pay factor adjustments and to assess the level of owners risk in material acceptance.

As part of the quality control, gyratory compaction tests may be performed. Since the 1930's, gyratory compaction has been used in asphalt mixture design under a procedure developed by the Texas Department of Transportation. The number of gyrations are expected to simulate pavement density at the end of life. The original gyrator compaction procedure was done manually. In the late 1950's-early 1960's, mechanized compactors were developed. These gyrators typically applied gyrations continuously while holding vertical pressure constant. In certain models, gyrations continue until the ratio of height change per revolution decreases below a predetermined limit. Other criteria for applying the gyrations include maintaining a constant angle during compaction, a constant vertical pressure, and a constant rate of gyration.

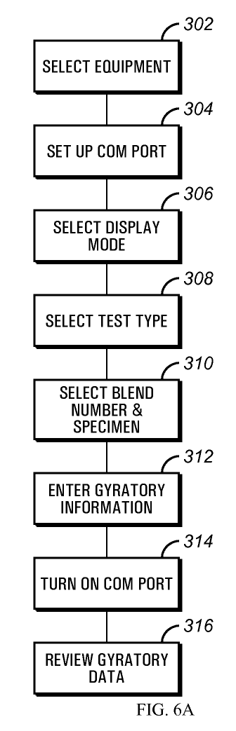

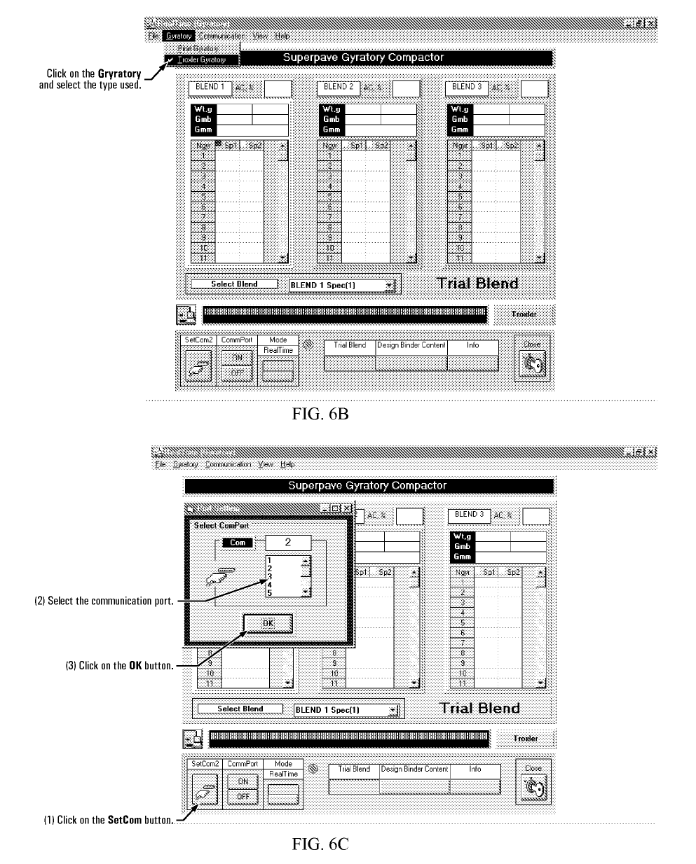

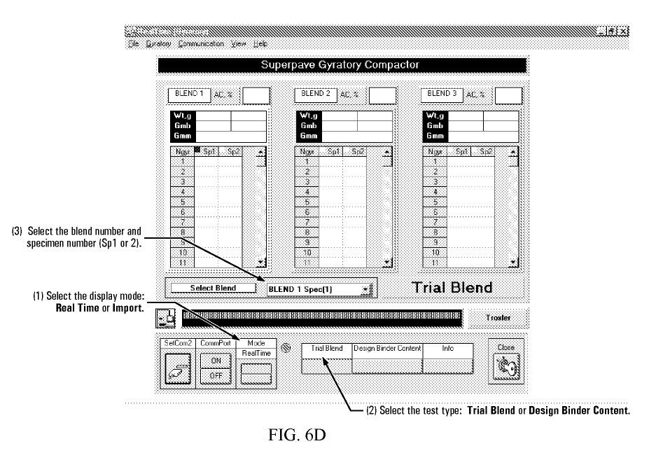

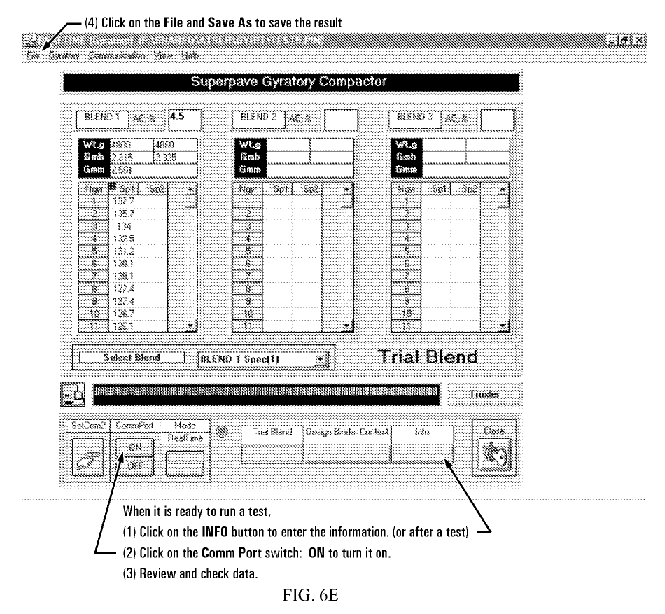

FIGS. 6A-6E show a process 300 and various user interfaces for performing gyratory compaction. First, the user selects a gyratory equipment type (step 302). The equipment can be a unit commercially available from a variety of vendors, including Test Quip, Inc. of New Brighton, Minn.; Rainhart Company of Austin, Tex.; Pine Instrument Company of Grove City, Pa.; and Troxler Electronic Laboratories, Inc. of Research Triangle Park, N.C. Next, the user sets up communications port with the equipment selected in step 302 (step 304). The user selects a display mode: Real Time or Import from a file (step 306). The user then selects a test type, in this embodiment a Trial Blend type or Design Binder Content type (step 308). Additionally, the user selects a blend number and specimen number (step 310). When the user is ready to run a test, the user clicks on an “Info” button to enter the information on the gyratory session (step 312). This information can also be entered after a test. The user then turns on the communication port (step 314), and review and check data generated by the gyratory equipment (step 316).

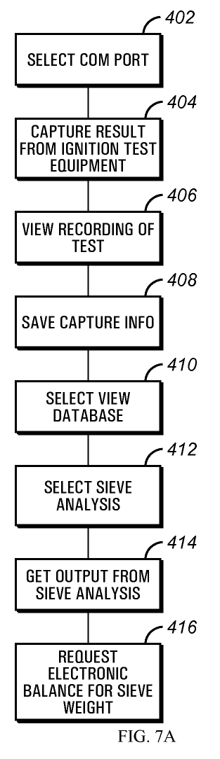

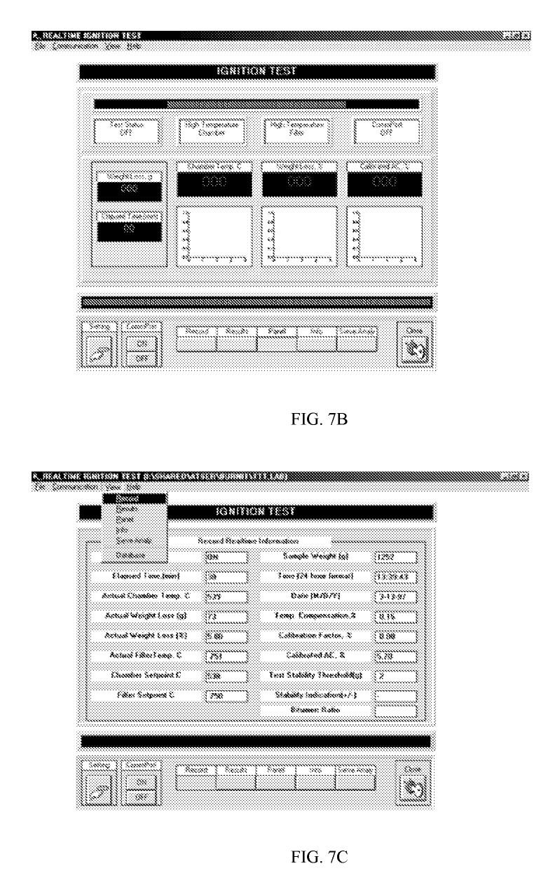

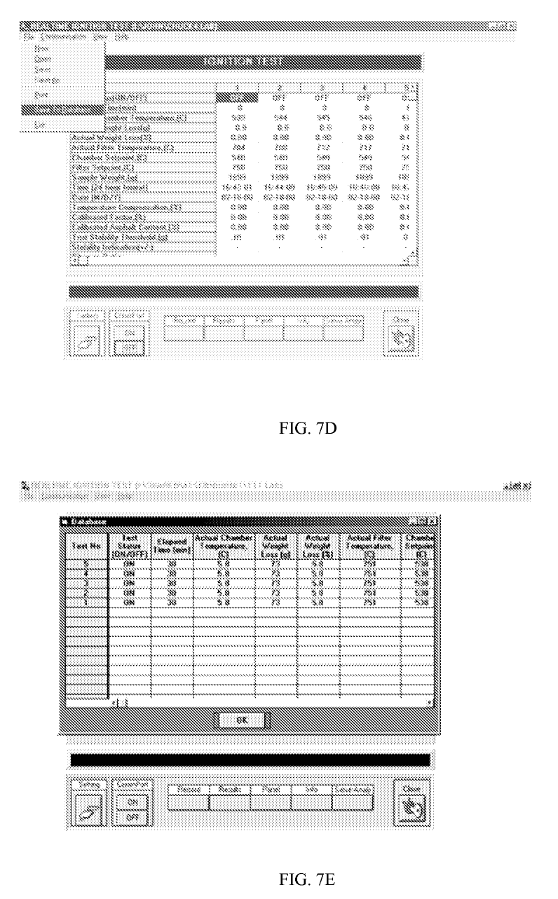

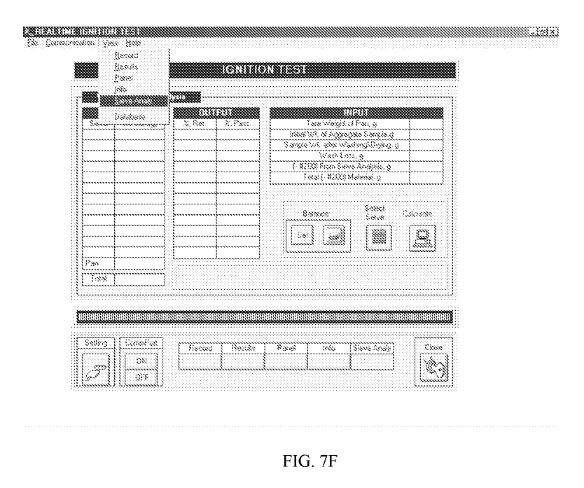

FIGS. 7A-7F show a process 400 and various user interfaces for performing ignition tests on materials. The process 400 supports a communication link between ignition furnaces to record chamber temperature, % weight loss, and calibrated % AC in a real-time tracking mode. In one exemplary implementation, an exemplary user interface is shown in FIG. 7A with a plurality of panel buttons which are also accessible from a menu bar under View. First, the user selects and turns on a particular communication port (step 402). Next, the user can capture the test results from a particular ignition test equipment through the selected port (step 404). In the embodiment of FIG. 7A, clicking on a “RECORD” button allows the user to see the test in real time. The user can also view a by-the-minute recording of the test after it is complete (step 406). In the embodiment of FIG. 4A, this can be done using a “RESULT” button. After completion, the user can save the captured information (step 408). In the embodiment of FIG. 7A, the user can select FILE and the Save from the menu bar to save the test results, first as a sequential file, and then select “Save to Database” to add it to an ignition database. The user can also print results to the printer. Next, the user can select View Database to view the Test results database of all tests completed (step 410). The tests are shown in order from last completed in one embodiment.

The user can also select a “Sieve Analysis” option, which allows the user to input sieve data and track results easily (step 412). After inputting results, the user can select “Calculate” to get output (step 414). The user can also specify a “Balance settings” option to initialize a communications interface to an electronic balance for sieve weights (step 416).

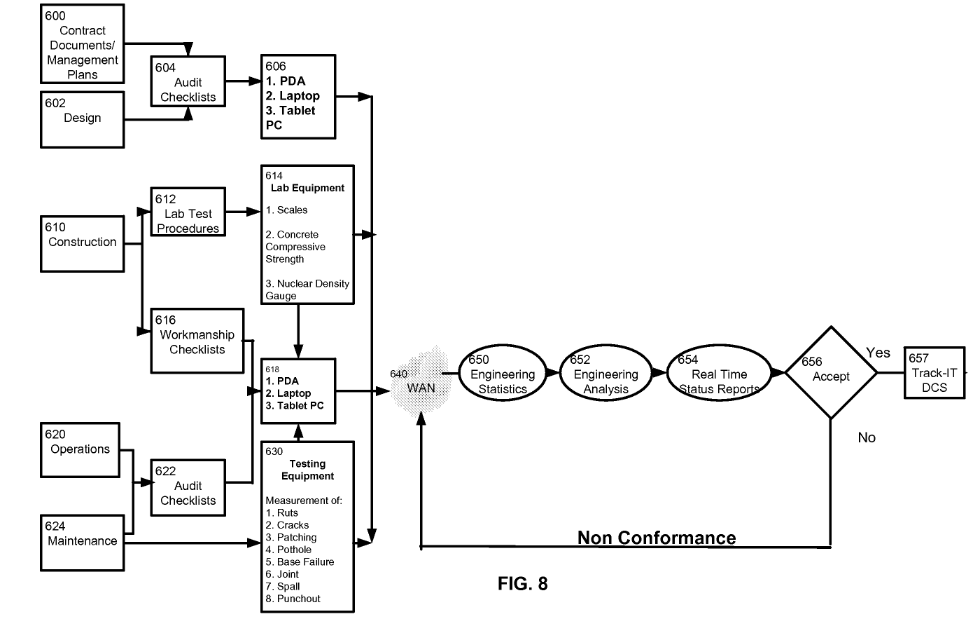

FIG. 8 shows another exemplary RMS. In FIG. 8, a management module 600 and a design module 602 provides an audit checklist 604 which can be sent to a portable computer 606. A construction module 610 provides lab test procedures 612 which communicates with Lab Equipment 614. RMS interfaces with lab equipment during the construction phase to pull in test data real-time to determine trends that could lead to non-compliances. The trending of the data is also used to audit the contractors test results. The data from the lab equipment is sent via the WAN to RMS. The equipment can connect to the WAN through the portable computer 606 such as a desktop, laptop, PDA, or tablet pc that has regular internet connection or a wireless internet connection. The lab equipment 614 that RMS interfaces with can include scales, concrete compressive strength machine, nuclear density gauge, soil unconfined compressive strength machine, among others.

The construction module 610 also generates a workmanship checklist 616 which can be accessed by a portable computer 618. The computer 618 can also receive audit checklists 622 from an operation module 620 or a maintenance module 624. The maintenance module can also communicate with testing equipment 630. RMS interfaces with testing equipment 630 during the maintenance phase to pull in test data real-time to determine trends that could lead to non-compliances. Determining non-compliances in the early stages can reduce life-cycle maintenance and replacement costs. The data from the testing equipment 630 is sent via the WAN to RMS. The equipment can connect to the WAN through a desktop, laptop, PDA, or tablet pc that has regular internet connection or a wireless internet connection. The testing equipment 630 that RMS interfaces with can include French Rutting Tester, depth gauge, Profilograph, and other maintenance machines, among others.

The information can be sent over a wide area network 640 to an engineering statistics module 650. The information can be sent to an engineering analysis module 652 and real time status reports 654 can be generated. The user can accept the result or alternatively keep receiving and analyzing field data collected from the WAN 640.

The system consolidates what is otherwise a Fragmented QA approach. The system provides a faster method of assessing quality in response to a compressed schedule. The system provides faster analytic turnaround to provide real time decision making rather than the traditional 24 hour reporting time lag between reporting and decision making. The system allows for real-time results and multiple users which are not available through spreadsheets or client server versions. The system effects a Complete System (Enterprise Solution) required for the owner to audit quality to protect assets and minimize cost in a real time environment. The system provides a Quality system that will ensure financiers (banks) that the asset is completed on schedule with high quality. Better, more economical process is supported that allows for mass production with approved quality and with multi-use by Engineering team. The system applies Scientific Knowledge to Solve a Human Problem. Financiers such as Banks will have asset completed on time thus minimizing cost and maximizing revenue By quickly reacting to non-conformances, the asset will be of good quality thus reducing maintenance and operations costs. The system minimizes Impact to the Orderly Sequence of Construction.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A computer-implemented method to analyze construction materials, contract and management plans, components or blends, comprising:
accessing a server located on a wide-area-network;
sending information collected from the materials, components or blends to the server;
applying one or more test or inspection methodologies to the collected information;
performing one or more audits;
generating one or more quality management reports from the test methodologies and the audits; and
sending the one or more quality management reports to a project manager.

2. The computer-implemented method of claim 1, further comprising applying aggregate test methodologies.

3. The computer-implemented method of claim 2, wherein the aggregate test methodologies include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate.

4. The computer-implemented method of claim 1 further comprising applying soil test methodologies.

5. The computer-implemented method of claim 5, wherein the soil test methodologies include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test.

6. The computer-implemented method of claim 1, further comprising applying asphalt test methodologies.

7. The computer-implemented method of claim 6, wherein the asphalt test methodologies include one or more of the following: Extraction; AES300 Emulsion Test; and ARA-1 Rejuvenate Agent.

8. The computer-implemented method of claim 1, further comprising applying asphalt mix test methodologies.

9. The computer-implemented method of claim 8, wherein the asphalt mix test and inspection methodologies include one or more of the following: Ignition Test; Actual Specific Gravity; Theoretical Maximum (Rice) Specific Gravity;
Tensile Strength Ratio; Marshall Stability; Hveem Stability and Voids Calculation.

10. The computer-implemented method of claim 1, further comprising applying concrete mix test methodologies.

11. The computer-implemented method of claim 11, wherein the concrete mix test methodologies include one or more of the following: Unit Weight, Yield, Air Content of Mix; Flexural Strength; Compressive Strength of Cylindrical Concrete Specimens; and Air Content.

12. The system of claim 12, further is comprising statistically comparing test results for engineering analysis and in determining pay factor adjustments and material acceptance.

13. A system for capturing data and analyzing quality conformance, comprising: a wide-area-network;
one or more client computers coupled to the wide-area-network, each client computer adapted to collect information relating to material properties; and
a server coupled to the wide-area network, the server applying one or more test methodologies to the collected information; generating one or more reports from the test methodologies; performing one or more audits; and sending the one or more reports and audit results to a project manager.

14. The system of claim 13, comprising quality assurance means for performing one or more of: quality control, quality acceptance, quality verification, quality validation, independence assurance, quality audits, contractor informational testing and inspection and others on construction material and or its components for design and installation of approved mix design submittals and such that the receipt is monitored for quality.

15. The system of claim 13, comprising means to perform statistical comparison of aggregate, asphalt, soils, and concrete test methodologies performed by various quality assurance laboratories and field technicians.

16. The system of claim 13, comprising means for applying quality compliance audits of testing methodologies, technicians, equipment, and contract specification and deliverables.

17. The system of claim 13, wherein collection field-testing and inspection audits are performed using portable computers for construction material components and mixtures and installation.

18. The system of claim 13, comprising a requirement management system to perform compliance audits of request for proposal requirements and providing audit status reports for management, design and construction key performance indicators of design and construction contract specifications items and tests, wherein the requirement management system interfaces with testing equipment including one of: a French Rutting Tester, a depth gauge, a Profilograph, a maintenance machine, and wherein the requirement management system interfaces with lab equipment including one of: a scale, a concrete compressive strength machine, a nuclear density gauge, a soil unconfined compressive strength machine.

19. The system of claim 13, wherein quality information for tests and inspection and audits comprise key performance indicators to drive a real-time quality assurance scorecard by comparing, monitoring, and tracking quality trends, issues and goals based on management, design, and construction criteria.

20. The system of claim 13, comprising means for applying trend analysis and correlation to generate electronic alerts and notifications when action levels, upper or lower limits, or performance indicators violate predetermined event triggers.
